(19) United States
(12) Patent Application Publication
(10) Pub. No.: US 2026/0086421 A1
(43) Pub. Date: Mar. 26, 2026

(54) Manufacturing Method for Wavelength Conversion Elements

(71) Applicant: NTT, Inc., Tokyo (JP)

(72) Inventor: Nobutatsu Koshobu, Musashino-shi, Tokyo (JP)

(21) Appl. No.: 19/111,153

(22) PCT Filed: Oct. 21, 2022
(86) PCT No.: PCT/JP2022/039370

§ 371 Date: Mar. 12, 2025

(51) Int. Cl. G02F 1/377; G02F 1/35; G02F 1/355

(52) U.S. Cl. CPC G02F 1/3775; G02F 1/3548; G02F 1/3551

(57) ABSTRACT

A manufacturing method for a wavelength conversion element, including: a first process of forming an optical waveguide core substrate having one or more periodic polarization inversion region with a second-order nonlinear effect; a second process of bonding the optical waveguide core substrate to a substrate having a refractive index lower than a refractive index of the optical waveguide core substrate in a range of used light wavelengths to form a bonded substrate, and thinning the optical waveguide core substrate to form a core layer; and a third process of processing the core layer of the bonded substrate to form an optical waveguide core, wherein, in the third process, a polarization inversion period of a periodic polarization inversion structure of the formed optical waveguide core is adjusted at least locally by selecting a formation position of the optical waveguide core with respect to the one or more periodic polarization inversion region.

### TECHNICAL FIELD

The present disclosure relates to a manufacturing method for wavelength conversion elements used in a wavelength conversion device.

### BACKGROUND ART

Wavelength conversion techniques are attracting attention in a wavelength region that cannot be directly output by a semiconductor laser or in applications that require high power light that cannot be obtained by a semiconductor laser even in a wavelength region that can be output. A wavelength conversion element used in a wavelength conversion device is realized by using an optical crystal or the like having a second-order nonlinear effect. As typical optical crystals having a second-order nonlinear effect, for example, LiNbO₃ (lithium niobate), KNbO₃ (potassium niobate), LiTaO₃ (lithium tantalate), or KTiOPO₄ (potassium titanate phosphate) are conceivable. In particular, an optical waveguide utilizing periodically poled lithium niobate (hereinafter, referred to as PPLN) is attracting attention as an element that can achieve high wavelength conversion efficiency by increasing a light intensity and using a quasi-phase matching technique. The PPLN is expected to be applied in a wide light wavelength range from the ultraviolet region to the terahertz region, and used in various fields such as optical signal wavelength conversion in optical communication, optical processing, medical treatment, and biotechnology.

Furthermore, it is possible to fabricate a parametric amplification element and a pump light generation element constituting a phase sensitive amplifier (PSA) capable of low noise optical amplification by using PPLN. For this reason, PPLN is being considered for application in devices which realizes high gain and low noise optical amplification characteristics and will play an important role in the next generation optical fiber communication field. Further, in the field of quantum computing, an optical waveguide utilizing the PPLN can be inserted into a fiber ring resonator and used as a parametric oscillation element. A report has been made to realize an optical coherent using machine device using this configuration and demonstrate large-capacity computation at a higher speed than a conventional computer.

A wavelength conversion element using a nonlinear optical waveguide having a periodic polarization inversion structure of an optical crystal having a second-order nonlinear effect such as LiNbO₃ (hereinafter referred to as a “nonlinear optical crystal”) is described, for example, in PTL 1.

PTL 1 discloses an example of fabricating a ridge-type optical waveguide. PTL 1 describes that a first substrate of a nonlinear optical crystal having a periodic polarization inversion structure and a second substrate having a refractive index less than that of the first substrate are bonded to each other to fabricate a wavelength conversion element in order to improve the confinement effect of light in a ridge-type optical waveguide.

Further, in PTL 1, after the process of bonding the first substrate and the second substrate, the first substrate is polished until the thickness thereof reaches 20 m, and then the substrate is etched to create a ridge-type optical waveguide. By setting the thickness of a nonlinear optical crystal film serving as an optical waveguide to 20m, a high power density can be obtained in the optical waveguide.

In addition, PTL 1 describes that a nonlinear optical crystal of the same type as that of the first substrate is used as the second substrate in order to avoid cracks due to deterioration of an adhesive or temperature change, and heat is applied to the first substrate and the second substrate to perform diffusion bonding. In the technical field utilizing such a wavelength conversion technique, it is important to realize a wavelength conversion device having higher wavelength conversion efficiency in order to further improve the performance.

However, a conventional wavelength conversion element using a ridge-type optical waveguide as described in PTL 1 has the following problems.

(a) a Problem with the Order of Process Steps, and a Problem that a QPM Period Cannot be Adjusted and Controlled in a Subsequent Process Because Periodic Polarization Inversion is Fabricated and Processed into an Optical Waveguide Shape

As described in PTL 1 above or the like, when a wavelength conversion element having an optical waveguide structure that satisfies a quasi-phase matching condition is fabricated, a nonlinear optical crystal having a large optical nonlinear constant (susceptibility) is often used as a material used as an optical waveguide core, and a material such as LiNbO₃ (lithium niobate), KNbO₃ (potassium niobate), LiTaO₃ (lithium tantalate), or KTiOPO₄ (potassium titanate phosphate) is used, for example.

In the case of the aforementioned nonlinear optical crystal, it is necessary to locally apply a very high electric field for polarization inversion in order to form a periodic polarization inversion structure. This electric field application is generally performed by forming a metal electrode pattern having a fine structure on a nonlinear optical crystal substrate and then applying a high voltage thereto. In this manner, a fine and complicated fabrication process is required to form the periodic polarization inversion structure. Therefore, at present, it is difficult to form an electrode to be used to apply an electric field for polarization inversion to an optical waveguide core after processing an optical waveguide core layer made of a nonlinear optical crystal into the shape of the optical waveguide core.

The following process is approximately generally used as a process for fabricating a wavelength conversion element composed of an optical waveguide core having the aforementioned periodic polarization inversion structure.

(1) First, a periodic polarization inversion structure is formed in advance on a material of an optical waveguide core layer.

Specifically, a high electric field in a specific direction is applied to the entire surface of a flat optical waveguide core substrate formed of the material of the optical waveguide core layer to align dielectric polarization domains of the entire substrate. Next, an electrode pattern for polarization inversion is fabricated on the surface of the substrate using a photomask pattern and a photolithography process in accordance with a polarization inversion structure having desired design values, and an inversion polarization structure is formed in uniform dielectric polarization by applying a high electric field. Thereafter, a photoresist and the electrode film are removed to complete the optical waveguide core substrate on which the periodic polarization inversion structure is formed.

(2) Next, the optical waveguide core substrate having the periodic polarization inversion structure formed thereon is bonded (attached) to a substrate having a refractive index lower than that of the optical waveguide core at the wavelength of light used. Specifically, the bonded surfaces of both substrates are polished to be flat and mirror surfaces, and the bonded surfaces of both substrates are bonded by thermal bonding, corona discharge, or the like.

(3) The bonded substrates are processed into a wafer shape or the like which can be used in a photo-process such as patterning using a photoresist which will be performed in a subsequent process by using a grinding and polishing device or the like. At this time, the film thickness of the optical waveguide core layer is made thinner to be equal to the film thickness of the optical waveguide core to be formed.

(4) Next, the optical waveguide core layer is processed to form an optical waveguide core. Specifically, after patterning the optical waveguide core layer into an optical waveguide core shape by using a photoresist or the like, the optical waveguide core is formed using a dry etching method, a dicing processing method, a proton exchange method, or the like.

Accordingly, a wavelength conversion element including an optical waveguide having a periodic polarization inversion structure is fabricated.

In the above-described wavelength conversion element fabrication process, the optical waveguide core substrate on which the periodic polarization inversion structure is formed in advance is bonded to a substrate having a low refractive index and thinned, and then the optical waveguide core structure is created. When the optical waveguide core layer is made thin and the optical waveguide core is processed thereafter, a processing error occurs. The effective refractive indexes n1, n2, and n3 of the optical waveguide core at each wavelength used indicated by the following (formula 10) do not have a single value due to the influence of the processing error generated at the time of processing the optical waveguide core, and become values fluctuating due to the processing error. In this manner, the processing error caused by the process after the polarization inversion structure is formed causes variations in optical characteristics such as the optical spectrum distribution of wavelength-converted light of the completed wavelength conversion element.

(b) a Problem that a Film Thickness Distribution in a Wafer Surface Cannot be Uniformly Processed

In the case of the above-described wavelength conversion element fabrication process, there is a problem that shape errors such as in the film thickness distribution are likely to occur at the time of processing the optical waveguide core.

The aforementioned fabrication process includes a process of fabricating a bonded substrate by bonding (attaching) an optical waveguide core substrate to a substrate having a refractive index lower than that of the optical waveguide core substrate. In this process, since two substrates having different linear thermal expansion coefficients are bonded to each other, warpage is likely to occur in the bonded substrates. For this reason, in the bonded substrates which need to inherently have a uniform film thickness, the film thickness is not uniform due to grinding and polishing steps of the thinning process of the optical waveguide core layer.

That is, the refractive index of the fabricated optical waveguide core varies due to the film thickness error of the optical waveguide core layer generated in the above fabrication process, and some errors will occur in the phase matching conditions of the periodic polarization inversion structure of the optical waveguide. Therefore, the wavelength conversion efficiency such as optical difference frequency generation is lowered, and optical characteristics such as the center wavelength and the light intensity of wavelength-converted light generated from the wavelength conversion element deviate from the design values.

Since such generated film thickness errors are found after processing of the optical waveguide core layer, when the optical waveguide core layer is processed in order to form the optical waveguide, the periodic polarization inversion structure of the optical waveguide fabricated using the optical waveguide core layer is determined, and thus it is actually impossible to correct the errors in accordance with processing errors such as film thickness errors.

In order to set the effective refractive index of the optical waveguide core to a desired set value, a photolithography process and dry etching are performed using a photomask pattern having a width varying in accordance with a variation of the film thickness, whereby the effective refractive index of the optical waveguide core can be corrected to some extent by varying the core width of the optical waveguide core. However, actually, a processing error occurs even when the optical waveguide core is formed, and thus there is a limit to setting the effective refractive index of the optical waveguide core to a desired set value. Further, since the fluctuation of the waveguide core width becomes a cause of increasing optical loss in the optical waveguide, the light intensity of control light or the like is reduced, and as a result, the efficiency of the wavelength conversion device is reduced.

### (c) a Problem in Film Thickness Accuracy Caused by Grinding and Polishing the Optical Waveguide Core Layer

In thinning of the optical waveguide core layer in the above-described wavelength conversion element fabrication process, a processing error is also generated. Therefore, with respect to the absolute value itself of the film thickness of the optical waveguide core layer, the processing depth varies slightly for each grinding and polishing process, resulting in variations in the film thickness of the fabricated optical waveguide core. That is, the same film thickness is not always obtained even after the same grinding and polishing process is performed. Further, in the order of submicrons, the average film thickness also varies, and thus a certain amount of variation occurs in the effective refractive index of the optical waveguide core. For this reason, since the quasi-phase matching conditions for individual optical waveguide cores also vary, for example, the center wavelength of the light wavelength of difference frequency generation light varies.

(d) a Problem that there is a Limit in Temperature Control Correction

The wavelength conversion element can perform highly accurate temperature control by using a temperature control element such as a Peltier element, thereby adjusting a quasi-phase matching condition by changing the effective refractive index of the optical waveguide due to temperature change by utilizing temperature dispersion of the effective refractive index of the optical waveguide, and for example, the center wavelength of difference frequency light generated due to difference frequency generation can be controlled to a certain extent.

However, although it is possible to perform an average correction for the effective refractive index of the optical waveguide to some extent by temperature control in response to a film thickness error of the wavelength conversion element, it is necessary to locally control the temperature of the optical waveguide core in order to correct the effective refractive index in response to a local film thickness distribution, this requires complicated temperature control elements and control circuits, and the like are complicated, and detailed control is required.

In fact, the temperatures of all wavelength conversion elements are not always completely the same, and a temperature distribution occurs inside the wavelength conversion element due to heat exchange with the temperature control element, a temperature difference between an environmental temperature and the wavelength conversion element, the state of radiant heat from the wavelength conversion element and the surroundings of the mounting structure, and the like. Therefore, even if the effective refractive indexes of the optical waveguide cores of the wavelength conversion elements are identical and have a unique value, variations in the effective refractive indexes occur in a certain constant width.

Since temperature control of a wavelength conversion device is also important as a control method at the time of correcting change in the environmental temperature during use, it is difficult to use temperature control only for correcting the film thickness and processing errors. Further, in temperature control of the wavelength conversion element, thermal diffusion due to direct thermal conduction occurs, and thus local temperature control of the wavelength conversion element is limited. From the above, there is a limit to using temperature control for adjusting the quasi-phase matching condition for the wavelength conversion element, for example, for controlling the center wavelength of difference frequency light according to generation of a difference frequency.

As described above, in the wavelength conversion element fabrication process as described above, there is a limit in correcting an error in the effective refractive index of the optical waveguide core caused by a film thickness variation in the optical waveguide core layer prior to the process of processing and forming the optical waveguide core in the process of forming the optical waveguide core or compensating for the error by temperature control, and thus there is a limit in yield improvement.

Therefore, there is a need for a method of controlling a quasi-phase matching condition for an optical waveguide core in response to an error caused by a processing error generated during a grinding and polishing process of thin film processing of an optical waveguide core layer or processing of the width of the optical waveguide core after generation of the processing error.

Specifically, there is a need for a method capable of at least locally controlling a polarization inversion period of a periodic polarization inversion structure of an optical waveguide core in a process of forming the optical waveguide core.

### CITATION LIST

### Patent Literature

[PTL 1] Japanese Patent No. 3753236

### SUMMARY OF INVENTION

The present disclosure is intended to solve the above problems, and an object thereof is mainly to at least locally control a polarization inversion period of a periodic polarization inversion structure of an optical waveguide core in a process of forming the optical waveguide core.

To achieve such an object, an embodiment of the present disclosure includes the following processes in a method of manufacturing a wavelength conversion element.

A manufacturing method for a wavelength conversion element includes: a first process of forming an optical waveguide core substrate having at least one periodic polarization inversion region with a second-order nonlinear effect; a second process of bonding the optical waveguide core substrate to a substrate having a refractive index lower than a refractive index of the optical waveguide core substrate at least in a range of used light wavelengths to form a bonded substrate, and thinning the optical waveguide core substrate to form an optical waveguide core layer; and a third process of processing the optical waveguide core layer of the bonded substrate to form an optical waveguide core,
wherein, in the third process, a polarization inversion period of a periodic polarization inversion structure of the formed optical waveguide core is adjusted at least locally by selecting a formation position of the optical waveguide core with respect to the at least one periodic polarization inversion region.

### BRIEF DESCRIPTION OF DRAWINGS

FIG. 1 is a perspective view showing a basic configuration of a wavelength conversion element fabricated by a manufacturing method of the present disclosure.

FIG. 2 is a diagram showing a configuration example of a mounting structure of a wavelength conversion device on which the wavelength conversion device element shown as the basic structure of FIG. 1 is mounted.

FIG. 3 is a diagram showing processes of a manufacturing method for a wavelength conversion element used in each embodiment of the present disclosure.

FIG. 4 is a schematic diagram illustrating the principle of adjusting a polarization inversion period of a periodic polarization inversion structure of an optical waveguide core according to a manufacturing method of a first embodiment of the present disclosure.

FIG. 5 is a schematic diagram illustrating the manufacturing method of the first embodiment of the present disclosure.

FIG. 6 is a schematic diagram illustrating a manufacturing method of a second embodiment of the present disclosure.

FIG. 7 is a schematic diagram illustrating another aspect of the manufacturing method of the second embodiment of the present disclosure.

FIG. 8 is a schematic diagram illustrating a second aspect of the manufacturing method of the second embodiment of the present disclosure.

FIG. 9 is a schematic diagram illustrating a manufacturing method of a third embodiment of the present disclosure.

FIG. 10 is a schematic diagram illustrating another aspect of the manufacturing method of the third embodiment of the present disclosure.

FIG. 11 is a schematic diagram illustrating a manufacturing method of a fourth embodiment of the present disclosure.

FIG. 12 is a schematic diagram illustrating an example of a position where an optical waveguide core is formed in the manufacturing method according to the fourth embodiment of the present disclosure.

FIG. 13 is a schematic diagram illustrating another example of a position where an optical waveguide core is formed in the manufacturing method according to the fourth embodiment of the present disclosure.

FIG. 14 is a schematic diagram illustrating another aspect of the manufacturing method of the fourth embodiment of the present disclosure.

FIG. 15 is a schematic diagram illustrating another aspect of the manufacturing method of the fourth embodiment of the present disclosure.

FIG. 16 is a schematic diagram illustrating a wavelength conversion element of a second example of the present disclosure.

### DESCRIPTION OF EMBODIMENTS

As a result of intensive studies in view of the above problems, the inventors of the present invention have completed the present invention by discovering that a quasi-phase matching condition can be adjusted by at least locally selecting a polarization inversion period of a polarization inversion structure of an optical waveguide core by optimizing the arrangement of a periodic polarization inversion region and the optical waveguide core and fabrication processes of the manufacturing method, and as a result, optical characteristics of wavelength conversion generating light can be varied.

Hereinafter, embodiments of the present invention will be described in detail with reference to the accompanying drawings.

### (Wavelength Conversion Device)

Prior to description of each embodiment of a manufacturing method of the present disclosure, a wavelength conversion device fabricated by the manufacturing method of the present disclosure will be described.

### (Description of Second-Order Nonlinear Optical Effect and Phase Matching Conditions)

In general, when signal light [wavelength: λ₁, frequency: ω₁] and pump light [wavelength: λ₂, frequency: ω₂] which have different wavelengths are incident on a second-order nonlinear optical crystal, wavelength-converted light (also referred to as idler light) [wavelength: λ₃, frequency: ω₃] generates light with a wavelength according to a relationship called a phase matching condition.

First, the case of sum-frequency generation, that is, ω₃=ω₁+ω₂ is considered.

Since the momentum of a photon is expressed as hk/(2π) by the Planck constant h and a wavenumber k, the following relationship is satisfied according to the law of conservation of momentum if wavenumber mismatch is Ak, the wavenumber of the signal light is k1, the wavenumber of the pump light is k2, and the wavenumber of wavelength-converted light is k3.

$$h Δ k / 2 π = h ( {k}_{3} - {k}_{1} - {k}_{2} ) / 2 π , \qquad ( Formula 1 )$$

$$accordingly ,$$

$$Δ k = {k}_{3} - {k}_{1} - {k}_{2} \qquad ( Formula 2 )$$

If the length of the second-order nonlinear optical crystal through which light propagates is L and the propagation direction is a Z direction, nonlinear polarization Pz(ω₁+ω₂) changes in phase at exp[i(k₁+k₂)Z], but the phase of sum frequency light E(ω₃), which is the generated wavelength-converted light, is exp(ik₃·Z), and thus the following relationship (Formula 3) is established therebetween.

$$exp ( i {k}_{3} \cdot Z ) - exp [ i ( {k}_{1} + {k}_{2} ) \cdot Z ] = exp [ i ( {k}_{3} - {k}_{1} - {k}_{2} ) \cdot Z ] = exp [ i Δ k \cdot Z ] \qquad ( Formula 3 )$$

From the above formula (3), the sum frequency light E(ω₃) and the nonlinear polarization Pz(ω₁+ω₂) have a phase difference of Δk·L.

When the phase difference exceeds π, the phase is inverted and the direction in which energy flows is inverted, and thus a process in which ω₃ photon is divided into ω₁ and ω₂ occurs. Accordingly, light waves of the sum frequency component that has been created begin to decrease.

Here, the distance Lc at which the phase is inverted, represented by the following formula 4, is referred to as a coherence length.

$$Lc = π / ( \vert Δ k \vert ) \qquad ( Formula 4 )$$

Further, when the phase difference exceeds 2π (that is, when the propagation length of light exceeds twice the coherence length), it can be ascertained that the direction in which energy flows return to the original direction again, and thus the nonlinear polarization Pz increases and decreases with a period of twice the coherence length (increase and decrease are exchanged for each coherence length). For this reason, in order to increase the generation efficiency of the wavelength-converted light, the coherence length at which attenuation starts needs to be made longer than the crystal length at which light propagates. In particular, the condition Δk=0 in which wavenumber mismatch is eliminated is referred to as a phase matching condition, which is a condition for generation of wavelength-converted light.

At this time, when two light waves having frequencies ω₁ and ω₂ are input to a second-order nonlinear material, as described above, and light having ω₃ (=ω₁+ω₂) is generated, it is called sum-frequency generation (SFG). On the other hand, when two light waves having frequencies ω₁ and ω₃ are input to a second-order nonlinear material and light having ω₂ (=ω₃-ω₁) is generated, it is called difference frequency generation (DFG).

Further, a phenomenon in which light having a frequency ω₃ and having a high light intensity is incident and two light waves having frequencies ω₁ and ω₂ are generated is called an optical parametric effect. Here, considering a case in which all light waves to be coupled travel in the same direction, since the wavenumber mismatch Ak is expressed as the following formula,

$$Δ k = 2 π ( {n}_{3} / {λ}_{3} - {n}_{1} / {λ}_{1} - {n}_{2} / {λ}_{2} ) \qquad ( Formula 5 )$$

the phase matching condition is expressed as follows.

$${n}_{3} / {λ}_{3} = {n}_{1} / {λ}_{1} + {n}_{2} / {λ}_{2} \qquad ( Formula 6 )$$

$$or$$

$${ω}_{1} {n}_{1} + {ω}_{2} {n}_{2} = {ω}_{3} {n}_{3} \qquad ( Formula 7 )$$

In the above formulas, n₁, n₂, and n₃ are refractive indexes of second-order nonlinear materials through which lights having wavelengths λ₁, λ₂, and λ₃ (frequencies: ω₁, ω₂, and ω₃) propagate. (Formula 7) means that the weighted average of n₁ and n₂ with the frequency as a weight is equal to n₃. Particularly in second harmonic generation, when fundamental wave photons to be coupled have the same polarization, the phase matching condition is satisfied when the refractive indexes of a fundamental wave and a double wave are equal. In practice, however, the phase matching condition is not easily satisfied because materials always have refractive index wavelength dispersion.

### (Description of Quasi-Phase Matching)

The aforementioned method is a method of eliminating wavenumber mismatch, that is, achieving Δk=0, but instead, there is a quasi-phase-matched (hereinafter referred to as QPM) method for allowing wavenumber mismatch and canceling the effect of phase shift by modulating nonlinear susceptibility. This is the idea proposed by Armstrong et al., 1962, and is a technique for achieving quasi-phase matching by a structure in which the sign of nonlinear susceptibility is periodically inverted. As described above, since nonlinear polarization increases or decreases with a length twice the coherence length as a period, nonlinear polarization waves generated from each point are summed without being canceled each other by setting twice the coherence length as a polarization inversion period (polarization inversion is performed at a coherence length interval), and it is possible to generate an effect as if the amount of phase mismatch has been set to 0 in a quasi manner.

If the polarization inversion period of the periodic polarization inversion structure is A, then the following formula 8 is established according to the formula (formula 4) of the coherent length.

$$Λ = 2 \cdot Lc \qquad ( Formula 8 )$$

Considering a case in which all light waves to be coupled travel in the same direction, wavenumber mismatch is non-zero according to (formula 4) and is represented as the following formula 9.

$$Δ k = 2 π ( {n}_{3} / {λ}_{3} - {n}_{1} / {λ}_{1} - {n}_{2} / {λ}_{2} ) = 2 π / Λ \qquad ( Formula 9 )$$

$$Therefore ,$$

$${n}_{3} / {λ}_{3} - {n}_{2} / {λ}_{2} - {n}_{1} / {λ}_{1} - 1 / Λ = 0 \qquad ( Formula 10 )$$

is established, and the formula (formula 10) is the phase matching condition of QPM. Here, n₃ is a refractive index at a wavelength λ₃, n₂ is a refractive index at a wavelength λ₂, and n₁ is a refractive index at a wavelength λ₁.

This QPM method has the advantages that it can use a material orientation which is the maximum component of the nonlinear susceptibility of a second-order nonlinear crystal or the like and an operating wavelength region can be set by selecting a polarization inversion period, and can confine light in a narrow area with high density and propagate the light over a long distance by using an optical waveguide, and thus can realize highly efficient wavelength conversion.

Further, several methods of fabricating a wavelength conversion element using the QPM method are known as described above. For example, there is a method of forming a nonlinear optical crystal substrate into a periodic polarization inversion structure, and then fabricating a proton exchange waveguide using the periodic polarization inversion structure. Another example is a method of forming a nonlinear optical crystal substrate into a periodic polarization inversion structure in the same manner, and then fabricating a ridge-type optical waveguide using a photolithography process and a dry etching process.

As a material used for an optical waveguide core of a wavelength conversion element, an optical crystal material having a second-order nonlinear effect is preferable, and as a material used for a substrate bonded to a substrate made of the material of the optical waveguide core, a material having a linear expansion coefficient close to that of the optical waveguide core material in order to reduce the influence of rupture caused by thermal stress due to temperature change, or the like is preferable. Specifically, LiNbO₃ (lithium niobate), KNbO₃ (potassium niobate), LiTaO₃ (lithium tantalate), LiNb₍ₓ₎Ta₍₁₋ₓ₎O₃ (0≤x≤1) (lithium tantalate with indefinite composition) or KTiOPO₄ (potassium titanate phosphate), or furthermore a material containing at least one selected from Mg (magnesium), Zn (zinc), Sc (scandium), or In (indium) as an additive thereto, are preferable as a material used for the optical waveguide core or a substrate to be bonded.

### (Structure of Wavelength Conversion Device)

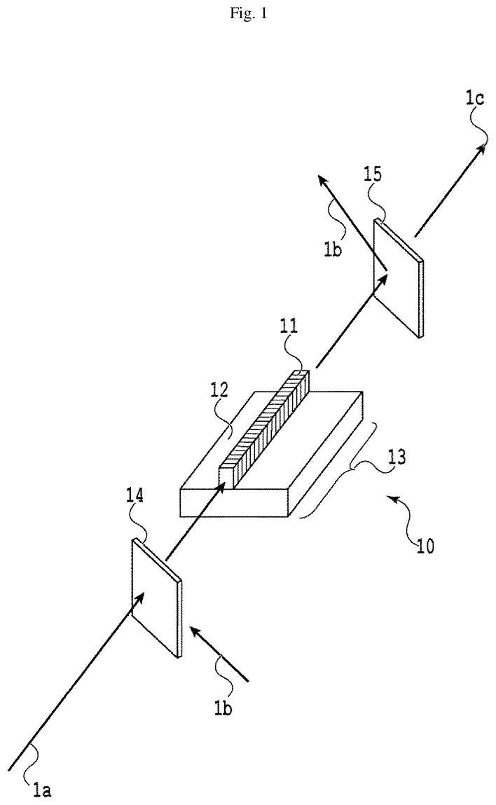

FIG. 1 is a perspective view of a basic configuration 10 of a wavelength conversion device of an embodiment of the present disclosure. The basic configuration 10 corresponds to a wavelength conversion element fabricated by a manufacturing method of the present disclosure. The basic configuration 10 shown in FIG. 1 shows a case in which it is applied as a wavelength conversion device for generating wavelength-converted light by utilizing the QPM method.

Only members constituting the basic configuration of the wavelength conversion device are shown in FIG. 1, and a wavelength conversion element 13, a multiplexer 14 and a demultiplexer 15 are shown. The wavelength conversion element 13 includes an optical waveguide core 11 and a substrate 12, and the optical waveguide core 11 is placed on the substrate 12. The optical waveguide core 12 is composed of a nonlinear optical crystal having a periodic polarization inversion structure.

The operation of the wavelength conversion device in the basic configuration shown in FIG. 1 will be described. As shown in FIG. 1, signal light 1a having low light intensity and pump light 1b having high light intensity are incident on the multiplexer 14 and multiplexed. The signal light 1a multiplexed with the pump light 1b travels toward the wavelength conversion element 13 and is incident on one end of the optical waveguide core 11. The signal light 1a is converted into difference frequency light 1c having a wavelength different from that of the signal light 1a while propagating in the optical waveguide core 11, and emitted from the other end of the optical waveguide core 11 along with the pump light 1b. The difference frequency light 1c and the pump light 1b emitted from the optical waveguide core 11 are incident on a demultiplexer 15 and separated from each other. The basic configuration 10 is a wavelength conversion device to which the signal light 1a is input and which generates light having a wavelength different from that of the signal light 1a.

In the basic configuration 10 shown in FIG. 1, the wavelength conversion element has a periodic polarization inversion structure in which the polarization direction of a ferroelectric crystal or a crystal lacking a symmetric center is periodically inverted by 180°, and includes an optical waveguide core satisfying a quasi-phase matching (QPM) condition. At this time, SHG generation, optical parametric oscillation, and the like using a wavelength conversion element by the QPM method are utilized.

Specifically, as described in the above quasi-phase matching method, the polarization inversion period of the periodic polarization inversion structure called the QPM condition is set to be twice the coherent length Lc. That is, the sign of the nonlinear optical constant d of the nonlinear optical crystal is inverted for each coherent length Lc.

In the optical waveguide core having the polarization inversion structure having the polarization inversion period twice the coherent length Lc, the phase of the second harmonic is inverted and the phase of the synthetic second harmonic from the coherent length Lc is corrected, and thus the light intensity of the generated second harmonic is added and the amplitude (intensity) of the second harmonic is increased to generate the second harmonic generation light. Further, in optical sum frequency generation and optical difference frequency generation, by setting the polarization inversion period of the periodic polarization inversion structure to be twice the coherent length Lc as described above, nonlinear polarized waves are summed without being canceled each other, and the nonlinear polarized waves are amplified.

The QPM method can use a material orientation which is the maximum component of the nonlinear susceptibility of a second-order nonlinear crystal or the like. In addition, the QPM method has the advantage that an operating wavelength region can be set by selecting an inversion period, and can confine light in a narrow area with high density and propagate the light over a long distance by using an optical waveguide.

It is known that the basic configuration 10 shown in FIG. 1 is accommodated together with a multiplexer and a demultiplexer in a metal housing having input/output ports capable of inputting and outputting light to constitute a light conversion device such that characteristics are not deteriorated due to changes in the use environment for practical use. Further, the wavelength conversion efficiency of the wavelength conversion element has temperature dependency, and it is necessary to control the temperature of the wavelength conversion element in order to maximize the wavelength conversion efficiency.

### (Mounting Structure of Wavelength Conversion Device)

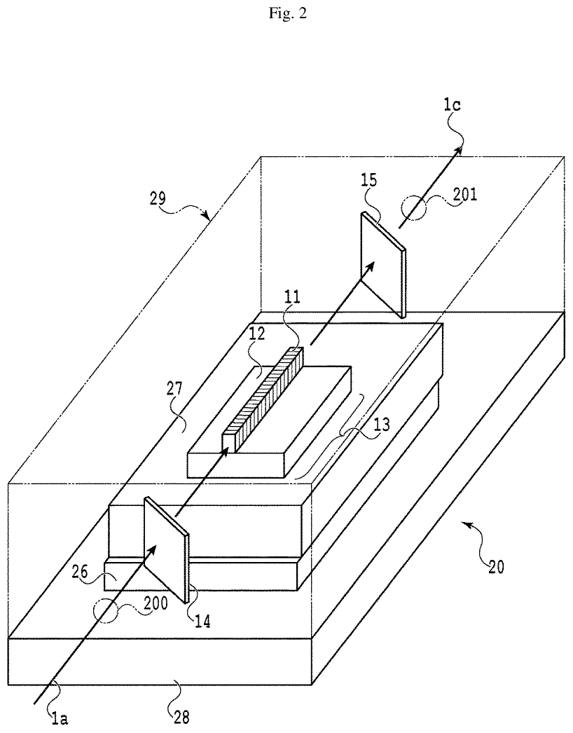

Next, the mounting structure of the wavelength conversion device will be described. FIG. 2 is a diagram illustrating a configuration example of the mounting structure of a wavelength conversion device 20 on which the basic configuration 10 of FIG. 1 is mounted.

The wavelength conversion device 20 shown in FIG. 2 further includes a metal housing bottom member 28, a lid member 29, and a temperature control element 26 in addition to the basic configuration 10 shown in FIG. 1. The metal housing bottom member 28 and the lid member 29 constitute a metal housing of the wavelength conversion device. In FIG. 2, the contour of the lid member 29 is indicated by a chain line, and members or the like accommodated in the metal housing are shown in a perspective view. The lid member 29 constituting the metal housing is provided with an input port 200 and an output port 201 for light, and the ports are indicated by dotted lines.

The wavelength conversion device 20 shown in FIG. 2 further includes a support member 27 for supporting the temperature control element 26. The support member 27 is a metal member for uniformly controlling the temperature of the entire wavelength conversion element 13 including the optical waveguide core 11 and the substrate 12. The temperature control element 26 is interposed between the support member 27 and the metal housing bottom member 28, and the temperature control element 26, the support member 27, and the metal housing bottom member 28 are bonded and fixed using a joining member (not shown) that has excellent heat conduction and is difficult to change its fixed position. The optical waveguide core 11, the substrate 12, the wavelength conversion element 13, the multiplexer 14, the demultiplexer 15, the signal light 1a, and the difference frequency light 1c are the same as those described in FIG. 1, and thus description thereof is omitted here.

Further, when a wavelength conversion element using a nonlinear optical crystal such as a ferroelectric crystal as an optical waveguide core material is used in a wavelength conversion device, a phenomenon called optical damage in which the refractive index of the optical waveguide core changes according to radiation of light having a short wavelength and the characteristics deteriorate occurs. As a method for curbing the influence of this optical damage, it has been proposed to use a wavelength conversion element at a high temperature. Therefore, in the wavelength conversion device 20 shown in FIG. 2, the temperature control element 26 is controlled to operate in an environment in a temperature range from around the room temperature to a temperature at which the adhesive for fixing the members does not deteriorate, in which the wavelength conversion element 13 does not form dew condensation, specifically, to be in a temperature range of about 20° C. or more and about 100° C. or less.

### (Manufacturing Method for Wavelength Conversion Elements)

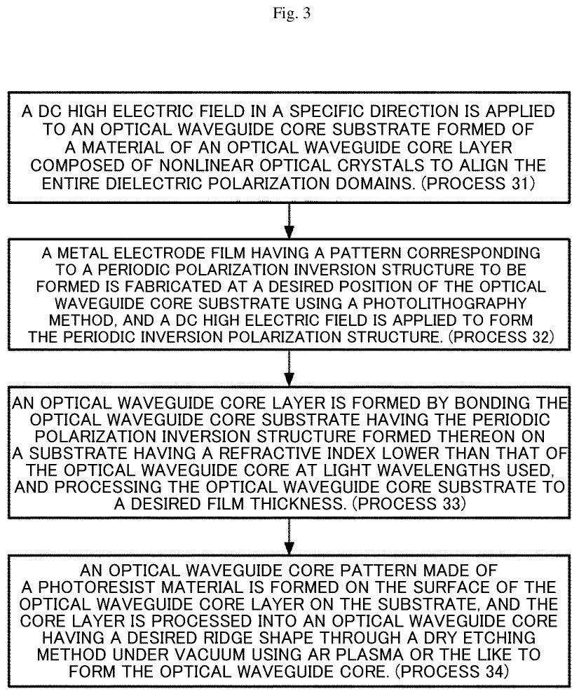

Next, a manufacturing method for the wavelength conversion element 13 described with reference to FIG. 1 and FIG. 2 will be described. FIG. 3 is a diagram showing processes of a manufacturing method for an optical waveguide core.

A high electric field in a specific direction is applied to the entire surface of a planar optical waveguide core substrate formed of nonlinear optical crystals as a wavelength conversion material, and the entire dielectric polarization domains are aligned. (Process 31)

Thereafter, a metal electrode film having a pattern corresponding to a periodic polarization inversion structure to be formed is fabricated at a desired position of the optical waveguide core substrate by using a photolithography method, a DC high electric field is applied to form the periodic polarization inversion structure, and the metal electrode film and an insulating film are removed to fabricate the optical waveguide core substrate. (Process 32)

Next, the optical waveguide core substrate on which the periodic polarization inversion structure is formed is bonded onto a substrate having a refractive index lower than that of the optical waveguide core at a light wavelength used using a surface activation method by plasma discharge or a thermal bonding method, and then processed into a core layer having a desired thickness through grinding and polishing to fabricate a bonded substrate. (Process 33)

An optical waveguide core pattern is formed of a photoresist material on the surface of the optical waveguide core layer on the bonded substrate, the core layer is processed into an optical waveguide core having a desired ridge shape, for example through a dry etching method under vacuum using Ar plasma or the like, and resist residues or the like on the surface of the optical waveguide core are cleaned and removed through Piranha cleaning to form the optical waveguide core. (Process 34)

### First Embodiment

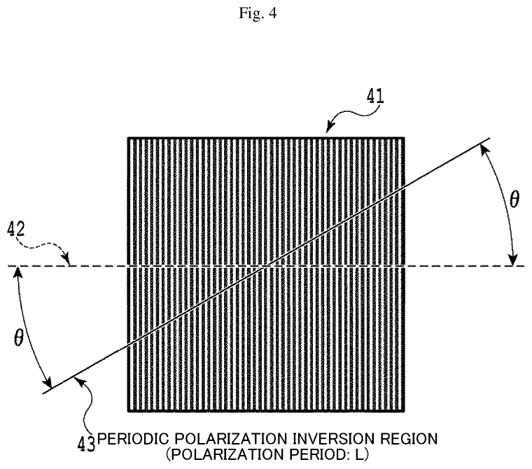

FIG. 4 is a schematic view illustrating the principle of adjusting a polarization inversion period of a periodic polarization inversion structure of an optical waveguide core according to a manufacturing method for a wavelength conversion element of a first embodiment of the present disclosure. A procedure of forming an optical waveguide core on the bonded substrate having the optical waveguide core layer in which a periodic polarization inversion region having a polarization inversion structure with a constant period has been formed through the processes 31 to 33, through the process 34 in the manufacturing method of the first embodiment of the present disclosure will be described with reference to FIG. 4.

FIG. 4 shows a periodic polarization inversion region 41 formed in the optical waveguide core layer. The polarization inversion region 41 shown in FIG. 4 has a periodic polarization inversion structure in which polarization is periodically inverted in one dimension from left to right in the figure. At this time, the boundary lines forming each polarization boundary of the polarization inversion region shown in FIG. 4 will be referred to as a “polarization boundary line” in the present specification.

Conventionally, in the process 34, a linear optical waveguide core is formed perpendicular to the polarization boundary lines as shown in the position where the optical waveguide core 42 is formed as indicated by the broken line in FIG. 4. On the other hand, in the first embodiment, the optical waveguide core is formed in the polarization inversion region as shown in the optical waveguide core formation position 43 indicated by the solid line in FIG. 4 in the process 34. That is, the first embodiment is characterized in that, in the process 34, a linear optical waveguide core is formed at a certain angle θ from perpendicular to the polarization boundary lines.

In the present specification, the “certain angle from perpendicular to the polarization boundary lines” when the optical waveguide is formed at the certain angle θ from perpendicular to the polarization boundary lines is referred to as an “an intersection angle with respect to the polarization inversion region” or an “intersection angle with respect to the polarization inversion structure.” Therefore, in the present specification, when the optical waveguide core is formed perpendicular to the polarization boundary lines as in the prior art, the intersection angle with respect to the polarization inversion region (structure) is expressed as 0 degrees in the optical waveguide core, and when the optical waveguide is formed at the certain angle θ from perpendicular to the polarization boundary lines as described above, the intersection angle with respect to the polarization inversion region (structure) is expressed as θ in the optical waveguide core.

By forming the optical waveguide at the intersection angle θ with respect to the polarization inversion region (structure) in this manner, the same effect as the case in which the polarization inversion period is extended 1/COS(0) times as compared with the case in which the polarization inversion period is formed at the intersection angle of 0 degrees in a quasi manner is generated. It can be understood from this fact that, in the process 34, by adjusting the intersection angle of the optical waveguide core formed in the periodic polarization inversion region with respect to the polarization inversion region, an optical waveguide core having a periodic polarization inversion structure with different polarization inversion periods can be fabricated using the periodic polarization inversion region having the same polarization inversion period.

Although the polarization inversion period length can be extended in a quasi manner even if the intersection angle with respect to the polarization inversion region is 45 degrees or more in principle, the optical spectrum distribution of wavelength-converted light generation is blunted, that is, the peak half-value width is increased actually when the intersection angle with respect to the polarization inversion region is 45 degrees or more. This is considered to be because the polarization boundary lines of the polarization inversion period become unclear. In order to prevent the polarization boundary lines of the polarization inversion period from becoming unclear as described above, it is desirable that the intersection angle θ with respect to the polarization inversion region be smaller, and it is desirable that the intersection angle is 30 degrees or less in practical use.

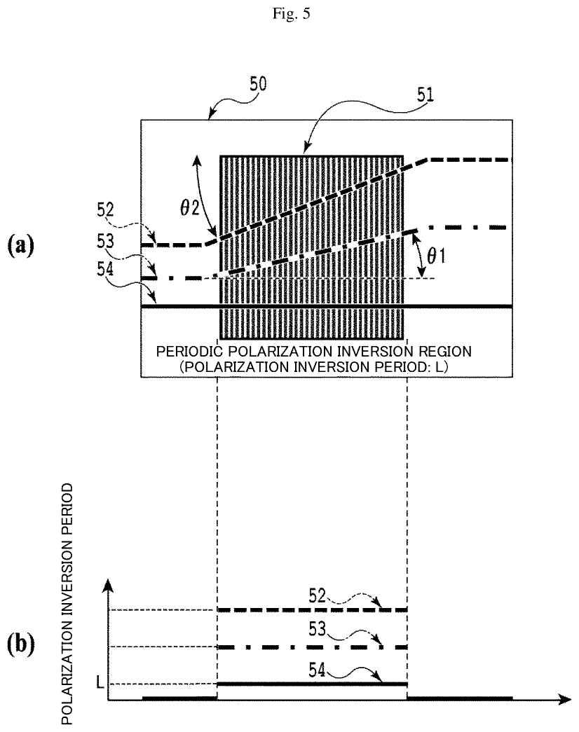

Next, a manufacturing method of the first embodiment of the present disclosure will be described with reference to FIG. 5. FIG. 5(a) shows a bonded substrate 50 in which one periodic polarization inversion region 51 having a polarization inversion period L is formed in a core layer through the processes 31 to 33 of FIG. 3. In this example, a case in which optical waveguide cores are created at optical waveguide core formation positions indicated by lines 52 and 53 in FIG. 5 in the process 34 is described. The periodic polarization inversion region 51 of FIG. 5 has a periodic polarization inversion structure in which polarization is one-dimensionally inverted from left to right in the figure with one polarization inversion period, as in FIG. 4.

It is desirable taha a material used for an optical waveguide core substrate or substrate to be bonded be LiNbO₃ (lithium niobate), KNbO₃ (potassium niobate), LiTaO₃ (lithium tantalate), LiNb(x)Ta(1−x)O₃ (0≤x≤1) (lithium tantalate with indefinite composition) or KTiOPO₄ (potassium titanate phosphate), or furthermore a material containing at least one selected from Mg (magnesium), Zn (zinc), Sc (scandium), or In (indium) as an additive thereto.

In this example, each line indicates a place where each waveguide core layer is formed when the optical waveguide core 52 formed at an intersection angle θ2 with respect to the polarization inversion region, the optical waveguide core 53 formed at an angle θ1, and an optical waveguide core 54 formed at an angle of 0 degrees have been formed in the periodic polarization inversion region of the optical waveguide core layer of one bonded substrate as optical waveguide cores to be formed in the periodic polarization inversion region.

The optical waveguide cores 52, 53, and 54 formed at the positions indicated by lines 52 to 54 in FIG. 5 can be used to manufacture a wavelength conversion element having a periodic polarization inversion structure having a polarization inversion period different from the polarization inversion period L by making the intersection angles different each other in the portions formed in the periodic polarization inversion region with respect to the polarization inversion region, as shown in FIG. 5(b).

As is apparent from this description, in the manufacturing method of the first embodiment, the wavelength conversion element having an optical waveguide core with a polarization inversion period different from the polarization inversion period L can be formed by selecting an intersection angle of the optical waveguide core formed in the optical waveguide core layer with respect to the polarization inversion region in the process 34 of FIG. 3. Therefore, the wavelength conversion element in which the polarization inversion period of the polarization inversion region has been adjusted in response to a processing error generated in the processes 31 to 33 of FIG. 3 can be created in the step of the process 34, for example. The present disclosure is not limited thereto, and it is also possible to fabricate a wavelength conversion element capable of discretely selecting a polarization inversion period by manufacturing a wavelength conversion element including a plurality of optical waveguide cores having different intersection angles with respect to polarization inversion regions and selecting any one thereof at the time of being mounted on a wavelength conversion device.

### Second Embodiment

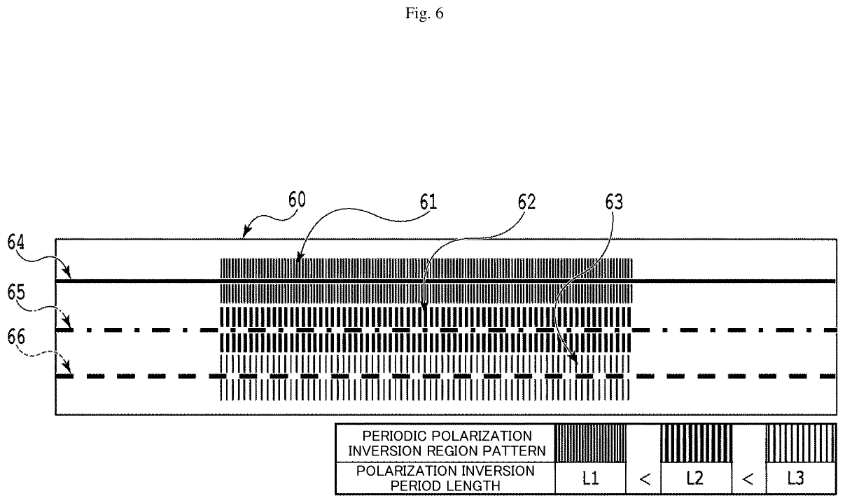

FIG. 6 is a diagram illustrating a manufacturing method of a second embodiment of the present disclosure. The manufacturing method of the second embodiment of the present disclosure is characterized in that, as shown in FIG. 6, at least two periodic polarization inversion regions having different polarization inversion periods are formed in an array form in the direction of polarization boundary lines on an optical waveguide core substrate in the process 32 shown in FIG. 3, and which polarization inversion period of the periodic polarization inversion regions will be used to form an optical waveguide core can be selected in the process 34 which is the subsequent process.

In the process 32, a plurality of polarization inversion regions can be formed on one optical waveguide core substrate by forming electrodes corresponding to periodic polarization inversion region patterns with a plurality of different polarization inversion periods on the surface of the optical waveguide core substrate, for example.

FIG. 6 shows a bonded substrate 60 in which three periodic polarization inversion regions 61, 62, and 63 are formed in an optical waveguide core layer as an example for describing the manufacturing method of the second embodiment. Each of the periodic polarization inversion regions has a periodic polarization inversion structure in which polarization is one-dimensionally inverted from left to right in the figure. In this example, the polarization inversion periods of the respective periodic polarization inversion regions are different, and the polarization inversion period lengths of the periodic polarization inversion regions 61, 62, and 63 are L1, L2, and L3, and the relationship of the periods is set to L1<L2<L3.

Further, in FIG. 6, positions at which an optical waveguide core 64 formed to pass over the periodic polarization inversion region 61, an optical waveguide core 65 formed to pass over the periodic polarization inversion region 62, and an optical waveguide core 66 formed to pass over the periodic polarization inversion region 62 are formed in the bonded substrate 60 are indicated by lines 64 to 66. In the second embodiment, as in the first embodiment, an optical waveguide core is formed by selecting any one of the positions of the optical waveguide cores 64 to 66 through the process 34 which is a process after the processes 31 to 33.

It is desirable that a material used for an optical waveguide core substrate or a substrate to be bonded be LiNbO₃ (lithium niobate), KNbO₃ (potassium niobate), LiTaO₃ (lithium tantalate), LiNb(x)Ta(1−x)O₃ (0≤x≤1) (lithium tantalate with indefinite composition) or KTiOPO₄ (potassium titanate phosphate), or furthermore a material containing at least one selected from Mg (magnesium), Zn (zinc), Sc (scandium), or In (indium) as an additive thereto.

In the second embodiment, which periodic polarization inversion region is used to form the optical waveguide core layer can be selected by selecting a position at which the optical waveguide core will be formed, that is, by selecting a periodic polarization inversion region through which the optical waveguide core will pass in the process 34. As a result, a wavelength conversion element including an optical waveguide core having periodic polarization inversion structures of different polarization inversion periods can be fabricated using one substrate.

Therefore, the wavelength conversion element in which the polarization inversion period of the polarization inversion region has been adjusted in response to a processing error generated in the processes 31 to 33 of FIG. 3 can be created in the step of the process 34, for example.

In the case of aligning a position at which the optical waveguide core will be formed in order to select a desired periodic polarization inversion region, the position at which the optical waveguide core will be formed can be aligned by using, for example, an alignment marker. In addition, the present disclosure is not limited thereto, and it is also possible to create a wavelength conversion element capable of discretely selecting a polarization inversion period by fabricating a wavelength conversion element having a plurality of optical waveguide cores 64 to 66 and selecting any one thereof at the time of being mounted in a wavelength conversion device.

As described above, by using the manufacturing method of the second embodiment, it is possible to obtain a wavelength conversion element having desired optical characteristics with a higher yield.

Although three periodic polarization inversion regions having different polarization inversion periods are illustrated in FIG. 6, the number of periodic polarization inversion regions may be at least two, and it is sufficient that an adjustment range of polarization inversion periods required can be adjusted discretely. In this case, it is desirable that the number of periodic polarization inversion regions be larger because fine adjustment is possible. Moreover, the intervals of the polarization inversion period lengths of the periodic polarization inversion regions do not need to be equal. For example, by forming a plurality of periodic polarization inversion regions having short periodic length intervals of polarization inversion periods with respect to a periodic range that requires more fine adjustment and forming a plurality of periodic polarization inversion regions having long periodic length intervals of polarization inversion periods with respect to other periodic ranges, the polarization inversion periods can be adjusted to desired polarization inversion periods practically.

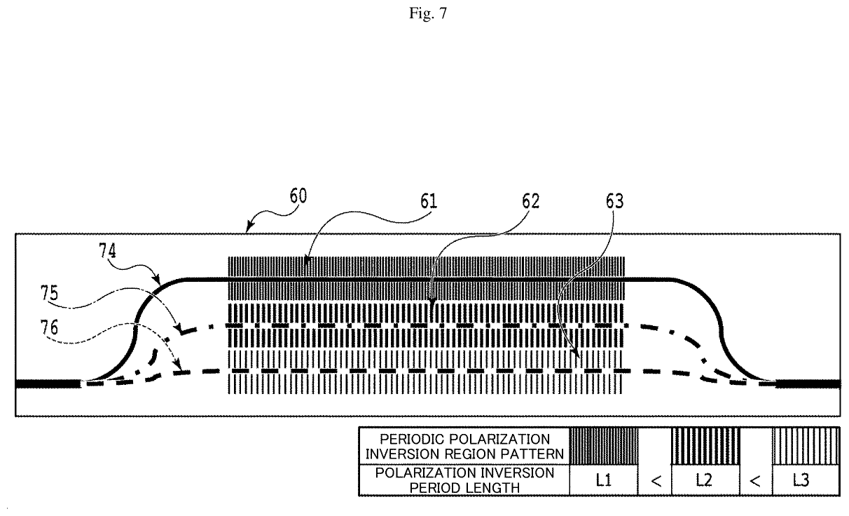

Next, another aspect of the manufacturing method of the second embodiment of the present disclosure will be described with reference to FIG. 7. The difference between FIG. 7 and FIG. 6 is that each optical waveguide core formed for selecting a periodic polarization inversion region is formed in a linear shape and the positions of the input/output ends are different in the example shown in FIG. 6, whereas the positions at which the input/output ends of each optical waveguide core will be formed are fixed in the aspect shown in FIG. 7.

In the aspect shown in FIG. 7, as in FIG. 6, at least two periodic polarization inversion regions having different polarization inversion periods are formed in an array form in the direction of the polarization boundary lines on the optical waveguide core substrate in the process 32 shown in FIG. 3, and which polarization inversion period of the periodic polarization inversion regions will be used to form an optical waveguide core is selected in the process 34 which is the subsequent fabrication process.

The bonded substrate 60 shown in FIG. 7 is the same as that shown in FIG. 6. In FIG. 7, three periodic polarization inversion regions 61, 62, and 63 are also formed in the optical waveguide core layer of the bonded substrate 60. Each of the periodic polarization inversion regions has a periodic polarization inversion structure in which polarization is one-dimensionally inverted from left to right in the figure, polarization inversion periods of the periodic polarization inversion regions 61, 62, and 63 are L1, L2, and L3, and the relationship of the periods is set to L1<L2<L3.

As indicated by lines 74, 75, and 76 in FIG. 7, even when any of the optical waveguide cores 74, 75, and 76 is formed in the process 34 in this aspect, the positions of the input/output ends of the optical waveguide cores formed are the same.

According to the manufacturing method of this aspect, by selecting and determining the position at which the optical waveguide core will be formed in the process 34 which is a subsequent process, a wavelength conversion element including an optical waveguide core having a periodic polarization inversion structure with different polarization inversion periods can be realized in the same optical waveguide chip shape in which the positions of input/output light are determined. As a result, the optical characteristics as the wavelength conversion element can be adjusted and controlled to desired optical characteristics.

In the aspect shown in FIG. 7, the concept of setting the number of periodic polarization inversion regions and the intervals of the polarization inversion period lengths between a plurality of periodic polarization inversion regions is the same as that of the second embodiment shown in FIG. 6, and thus the description thereof will be omitted.

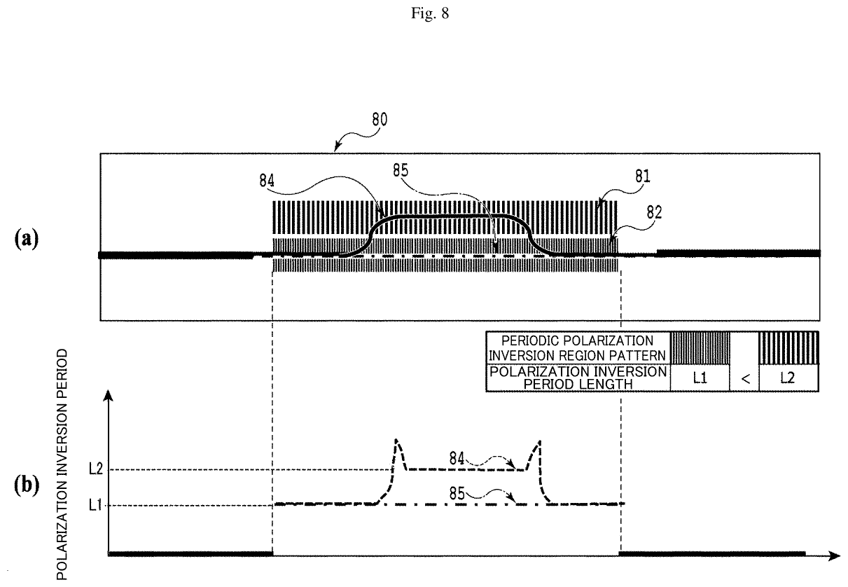

Further, another aspect of the second embodiment of the present disclosure will be described with reference to FIG. 8. The difference between FIGS. 6 and 7 and the aspect shown in FIG. 8 is that the optical waveguide core formed in the process 34 is formed to pass over one periodic polarization inversion region in FIGS. 6 and 7, whereas the optical waveguide core is formed to pass over a plurality of periodic polarization inversion regions in the example shown in FIG. 8.

In the manufacturing method of this aspect, at least two periodic polarization inversion regions having different polarization inversion periods are formed and arranged in an array form in the direction of polarization boundary lines in an optical waveguide core substrate in the process 32 shown in FIG. 3, and which polarization inversion period of the polarization inversion period regions will be used to form an optical waveguide core is selected in the process 34 which is the subsequent fabrication process.

As shown in FIG. 8(a), periodic polarization inversion regions 81 and 82 having a plurality of different polarization inversion periods are formed in the optical waveguide core layer of the bonded substrate in the process 32. Each of the periodic polarization inversion regions has a periodic polarization inversion structure in which polarization is one-dimensionally inverted from left to right in the figure, polarization inversion periods of the periodic polarization inversion regions 81 and 82 are set to L1 and L2, and the relationship between the periods is set to L1>L2.

As indicated by lines 84 and 85 in FIG. 8(a), this example shows an example of a manufacturing method for forming the optical waveguide core 84 in the process 34. By forming the optical waveguide core 84 as indicated by the line 84 in FIG. 8(a), it is possible to form an optical waveguide core having a periodic polarization inversion structure with locally different polarization inversion periods although slight pulse-like disturbance in the polarization inversion period occurs at positions crossing the two different periodic polarization inversion regions 81 and 82 as shown in FIG. 8(b).

Accordingly, by forming one optical waveguide core to pass over periodic polarization inversion regions having a plurality of different polarization inversion periods, it is possible to adjust and control the local polarization inversion period of the periodic polarization inversion structure of the optical waveguide core.

Although an example in which two periodic polarization inversion regions having different polarization inversion periods are formed is shown in the example of FIG. 8 in order to simplify description, three or more periodic polarization inversion regions may be formed to cross the respective periodic polarization inversion regions. Further, the number of periodic polarization inversion regions is sufficient as long as an adjustment range of polarization inversion periods required can be adjusted discretely. In this case, it is desirable that the number of periodic polarization inversion regions be larger because fine adjustment is possible. Moreover, the intervals of the polarization inversion periods of the respective periodic polarization inversion regions do not need to be equal.

Further, although the optical waveguide core 84 is formed to cross the periodic polarization inversion region 82 to the periodic polarization inversion region 81 and then to cross the periodic polarization inversion region 81 to the periodic polarization inversion region 82 in this example, the number of times of crossing and the place of crossing may be appropriately set in accordance with the adjustment range of a polarization inversion period required.

As described above, in this example, the optical waveguide core layer can be formed by selecting the position at which the optical waveguide core will be formed and locally selecting the periodic polarization inversion region through which the optical waveguide core passes in the process 34. As a result, a wavelength conversion element including an optical waveguide core having a periodic polarization inversion structure with locally different polarization inversion periods can be fabricated using one substrate.

Therefore, for example, the wavelength conversion element in which the polarization inversion period of the polarization inversion region is locally adjusted in the step of the process 34 can be fabricated in response to a processing error generated in the processes 31 to 33 shown in FIG. 3.

### Third Embodiment

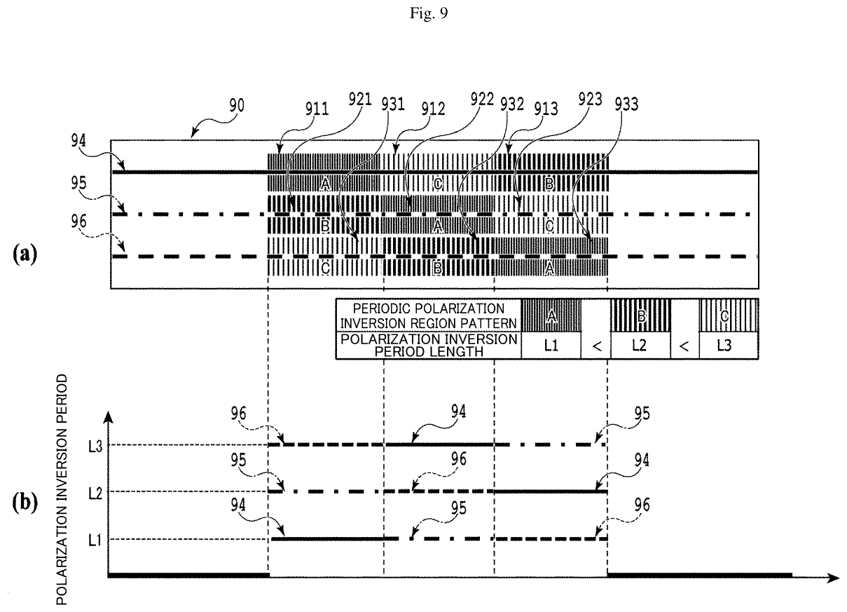

FIG. 9 is a schematic diagram illustrating a manufacturing method of a third embodiment of the present disclosure. In the manufacturing method of the third embodiment of the present disclosure, at least four periodic polarization inversion regions having polarization inversion structures with different polarization inversion periods are formed on an optical waveguide core substrate in an two-dimensional array arrangement in which a plurality of periodic polarization inversion regions are formed not only in the direction of polarization boundary lines but also in the direction perpendicular to the polarization boundary lines in the process 32 shown in FIG. 3, and which periodic polarization inversion region will be used to form an optical waveguide core is selected in the process 34 which is the subsequent fabrication process.

FIG. 9(a) shows a bonded substrate 90 in which nine periodic polarization inversion regions 911 to 913, 921 to 923, and 931 to 933 in a 3×3 two-dimensional array form in which three are arranged in the optical waveguide core layer in the direction of polarization boundary lines and three are arranged in the direction perpendicular to the polarization boundary lines are formed as an example for describing the manufacturing method of the third embodiment. Each of the periodic polarization inversion regions has a periodic polarization inversion structure in which polarization is one-dimensionally inverted from left to right in the figure. In this example, each periodic polarization inversion region is formed in any one of polarization inversion structures A, B, and C having three different polarization inversion periods as shown by each of patterns A to C in the figure. The polarization inversion structures A, B, and C have polarization inversion period lengths L1, L2, and L3, and the relationship of the periods is set to L1<L2<L3.

Further, in FIG. 9(a), in the bonded substrate 90, positions at which an optical waveguide core 94 formed to pass over the periodic polarization inversion regions 911 to 913, an optical waveguide core 95 formed to pass over the periodic polarization inversion regions 921 to 923, and an optical waveguide core 96 formed to pass over the periodic polarization inversion regions 931 to 933 will be formed are indicated by lines 94 to 96. In the third embodiment, any one of the optical waveguide cores 94 to 96 is also formed through the process 34 which is a process after the processes 31 to 33.

It is desirable that a material used for an optical waveguide core substrate or a substrate to be bonded be LiNbO₃ (lithium niobate), KNbO₃ (potassium niobate), LiTaO₃ (lithium tantalate), LiNb(x)Ta(1−x)O₃ (0≤x≤1) (lithium tantalate with indefinite composition) or KTiOPO₄ (potassium titanate phosphate), or furthermore a material containing at least one selected from Mg (magnesium), Zn (zinc), Sc (scandium), or In (indium) as an additive thereto.

In this example, the periodic polarization inversion regions 911 to 913, 921 to 923, and 931 to 933 selected by the optical waveguide formation positions 94 to 96 include regions composed of the three polarization inversion structures A, B, and C having different polarization inversion periods, and the orders of the regions composed of the three polarization inversion structures A, B, and C from left to right in the figure are different.

Therefore, according to this embodiment, it is possible to select whether to form an optical waveguide core using the polarization inversion regions 911 to 913, 921 to 923, or 931 to 933 by selecting a position at which the optical waveguide core will be formed in the process 34. As a result, it is possible to fabricate a wavelength conversion element including an optical waveguide core having a polarization inversion structure with a locally different polarization inversion period and having a different local distribution of the polarization inversion period using one substrate.

In FIG. 9(b), local distributions of the polarization inversion periods of the periodic polarization inversion regions of the optical waveguide cores formed at positions corresponding to the respective lines 94 to 96 shown in FIG. 9(a) are indicated by using the same kind of lines. The optical waveguide core formed by selecting the position indicated by the line 94 in FIG. 9(a) has a local distribution of the polarization inversion period indicated by the line 94 in FIG. 9(b). The local distributions of the polarization inversion periods of the optical waveguide cores 95 and 96 formed by selecting the positions indicated by the lines 95 and 96 are also indicated in the same manner.

Therefore, it is possible to fabricate a wavelength conversion element having an optical waveguide core with a local distribution of polarization inversion periods corresponding to a film thickness distribution variation pattern assumed to occur due to a processing error by two-dimensionally arranging periodic polarization inversion regions in a plurality of patterns corresponding to local polarization inversion periods that require correction in response to film thickness distribution variation assumed to be corrected on a substrate on the basis of film thickness distribution data of an optical waveguide core layer caused by a processing error in a past manufacturing process, or the like, for example. Further, in this example, even if any of the positions 94 to 96 is selected as an optical waveguide core formation position, an optical waveguide core formed includes one region composed of three types of polarization inversion structures A, B, and C, and thus there is no local change in film thickness or the like, and if the all effective refractive indexes of the optical waveguide core is the same in the polarization inversion periods 911 to 933, optical waveguides satisfying the same phase matching condition are obtained by the respective optical waveguide cores 94 to 96.

Although the periodic polarization inversion regions arranged on the bonded substrate 90 are arranged in a 3×3 two-dimensional array form in FIG. 9, 2×2 four periodic polarization inversion regions or more may be arranged in the bonded substrate 90, and the numbers of periodic polarization inversion regions arranged in the polarization boundary line direction (vertical direction in the figure) and the direction perpendicular to the polarization boundary line direction (horizontal direction in the figure) may be different. The number of periodic polarization inversion regions arranged in the bonded substrate 90 may be appropriately selected in accordance with a film thickness distribution variation pattern assumed to be corrected. Although three kinds of polarization inversion structures having different polarization inversion period lengths are shown in FIG. 9, four or more kinds of polarization inversion structures may be used. In this case, by preparing many kinds of polarization inversion structures having different polarization inversion period lengths, a local distribution of polarization inversion periods can be finely adjusted in response to a film thickness distribution pattern. Moreover, the intervals of the polarization inversion period lengths of the types of polarization inversion structures having different polarization inversion periods do not need to be equal. Further, although any of the periodic polarization inversion regions selected by an optical waveguide core formation position consists of periodic polarization inversion regions composed of three kinds of polarization inversion structures having different polarization inversion periods in FIG. 9, the types of polarization inversion structures constituting selected periodic polarization inversion regions may not be the same. Further, some of types of polarization inversion periodic structure prepared in advance may be selected to constitute a periodic polarization inversion region. Although there are three kinds of positions 94 to 96 at which optical waveguide cores will be formed in FIG. 9, two or more kinds of positions may be used, and four or more kinds of positions may be used. The present disclosure is not limited thereto, and it is also possible to create a wavelength conversion element capable of discretely selecting a polarization inversion period by fabricating a wavelength conversion element having a plurality of optical waveguide cores 94 to 96 and selecting any one thereof at the time of being mounted in a wavelength conversion device.

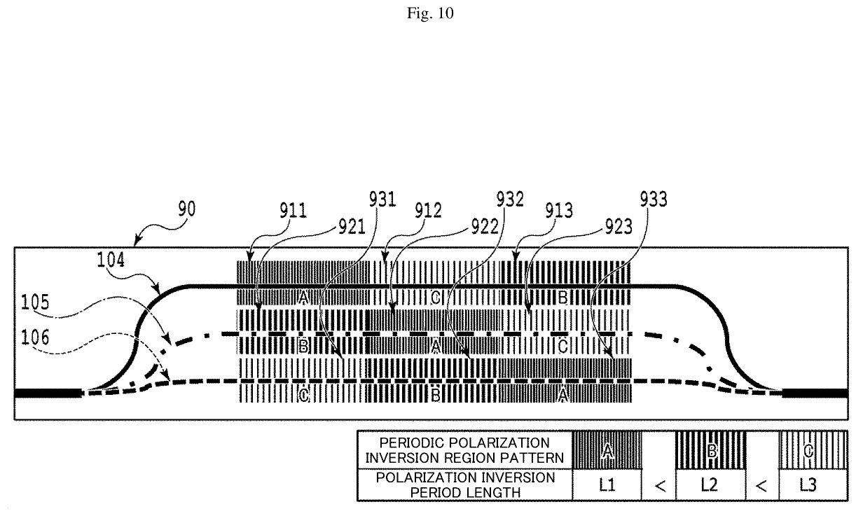

Next, another aspect of the manufacturing method of the third embodiment will be described using FIG. 10. The difference between FIG. 10 and FIG. 9 is that the optical waveguide cores 94 to 96 formed for selecting a periodic polarization inversion region are formed in a linear shape and have different input/output end formation positions in the aspect shown in FIG. 9, whereas positions at which the input/output ends of the optical waveguide cores are formed are fixed in the aspect shown in FIG. 10. The bonded substrate 90 shown in FIG. 10 is the same as that shown in FIG. 9, and components denoted by the same symbols are the same as in FIG. 9, and thus description thereof will be omitted.

As indicated by lines 104, 105, and 106 in FIG. 10, in the manufacturing method of this aspect, optical waveguide cores 104, 105 and 106 are formed such that the positions of the input/output ends of the optical waveguide cores to be formed are the same even when any of the optical waveguide cores 104, 105 and 106 is formed in the process 34. According to the manufacturing method of this aspect, as in FIG. 10, it is possible to realize a wavelength conversion element including an optical waveguide core having a polarization inversion structure in which polarization inversion periods are locally different and having a locally different distribution of polarization inversion periods in the same optical waveguide chip shape in which the position of input/output light is determined using one substrate. In FIG. 10, since the concept of the number of periodic polarization inversion regions arranged in the bonded substrate 90, the number of types of polarization inversion structures having different periods to be used, the arrangement order, and the like are the same as those in the third embodiment shown in FIG. 9, description thereof is omitted here.

### Fourth Embodiment

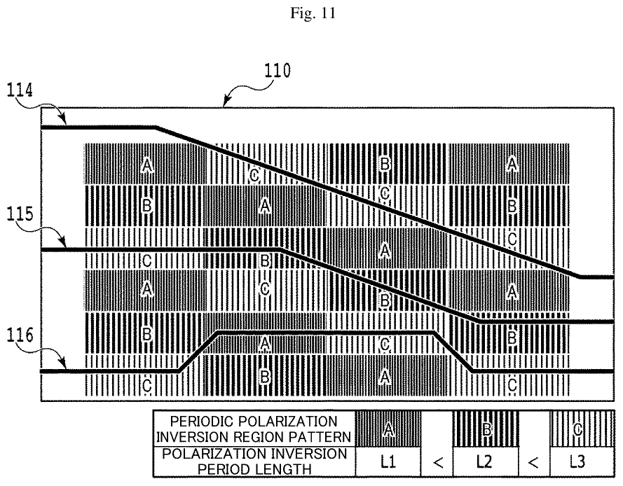

FIG. 11 is a schematic diagram illustrating a manufacturing method of a fourth embodiment of the present disclosure. In the fourth embodiment of the present disclosure, periodic polarization inversion regions are formed to be arranged in a two-dimensional array form in the process 32 shown in FIG. 3 as in the third embodiment, and by selecting a position at which an optical waveguide core will be formed and determining a polarization inversion region through which the optical waveguide core passes, which periodic polarization inversion region will be used to manufacture the optical waveguide core is determined in the process 34. The fourth embodiment is characterized in that a position at which an optical waveguide core will be formed is determined to be a path in which an intersection angle with respect to a polarization inversion region is not only 0 degrees but also a predetermined angle in the process 34.

In the second and third embodiments, only the polarization inversion period length of a selected periodic polarization inversion region is directly utilized. On the other hand, in the fourth embodiment, the effect of extending the polarization inversion period 1/COS(θ) times is utilized by changing the intersection angle θ of the optical waveguide core passing over the periodic polarization inversion region with respect to the polarization inversion region, as described in the first embodiment. As described above, in the fourth embodiment, not only the polarization inversion periods of the periodic polarization inversion regions arranged in a two-dimensional array form are used, but also fine adjustment of the values of polarization inversion periods between discrete periodic polarization inversion regions can be performed.

FIG. 11 shows an example in which 24 polarization inversion regions each composed of one of polarization inversion structures A, B, and C with different polarization inversion periods having three types of period lengths L1, L2, and L3 are arranged in a 6×4 two-dimensional array form in a bonded substrate 110. In the manufacturing method of the fourth embodiment, a plurality of periodic polarization inversion regions shown in FIG. 11 are also formed on an optical waveguide core substrate through the process 32 shown in FIG. 3. The 24 polarization inversion regions in FIG. 11 are arranged such that adjacent periodic polarization inversion regions have different polarization inversion periods, as is apparent from the figure. In addition, three kinds of polarization inversion regions constituted by polarization inversion structures A, B, and C are arranged in the vertical direction (direction parallel to polarization boundary lines) and the horizontal direction (direction perpendicular to the polarization boundary lines) in the figure such that they have the same repetitive pattern. These periodic polarization inversion regions have a periodic polarization inversion structure in which polarization is one-dimensionally inverted from left to right in the figure.

Further, in FIG. 11, positions at which optical waveguide cores 114 to 116 formed in an optical waveguide core layer of the bonded substrate 110 in the process 34 shown in FIG. 3 will be formed are indicated by lines 114 to 116. In the manufacturing method of the fourth embodiment, any one of the optical waveguide cores 114 to 116 is also formed through the process 34 which is a process after the processes 31 to 33 as in the manufacturing methods of the first to third embodiments.

It is desirable that a material used for an optical waveguide core substrate or a substrate to be bonded be LiNbO₃ (lithium niobate), KNbO₃ (potassium niobate), LiTaO₃ (lithium tantalate), LiNb(x)Ta(1−x)O₃ (0≤x≤1) (lithium tantalate with indefinite composition) or KTiOPO₄ (potassium titanate phosphate), or furthermore a material containing at least one selected from Mg (magnesium), Zn (zinc), Sc (scandium), or In (indium) as an additive thereto.

The optical waveguide core 114 formed at the position indicated by the line 114 in FIG. 11 is formed to have a polarization inversion structure in which a periodic polarization inversion region constituted by the periodic polarization inversion structure C having the same polarization inversion period L3 is formed at the same polarization inversion region intersection angle. Therefore, in this case, when the polarization inversion region intersection angle is θ, it is possible to form an optical waveguide core having a polarization inversion structure having a polarization inversion period length of L3/COS(θ). In addition, as indicated by the lines 115 and 116 in FIG. 11, by selecting an optical waveguide core formation position by setting the polarization inversion region intersection angle of only a part of the optical waveguide core passing through the periodic polarization inversion regions as a predetermined angle θ, it is possible to form an optical waveguide core having a periodic polarization inversion structure having locally different polarization inversion periods.

In this manner, in the fourth embodiment of the present disclosure, it is possible to select a periodic polarization inversion region for forming an optical waveguide core and adjust the polarization inversion region intersection angle θ with respect to the selected periodic polarization inversion region by selecting a position at which the optical waveguide core will be formed in the process 34.

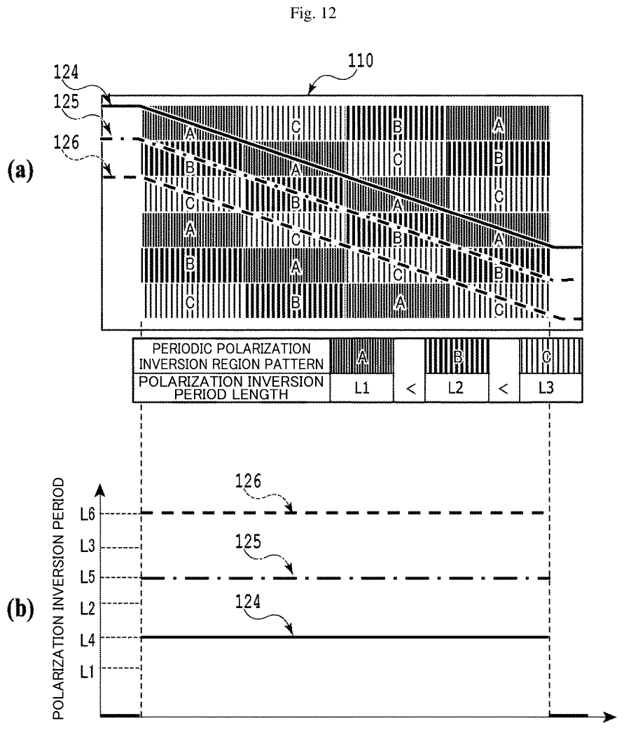

In the fourth embodiment of the present disclosure, a local distribution of periodic polarization inversion period lengths of an optical waveguide core can be adjusted more freely in the process 34. For example, in FIG. 12(a), as indicated by lines 124 to 126, the formation positions indicated by the lines 124 to 126 are set such that an optical waveguide core is formed to pass through a periodic polarization inversion region constituted by the same polarization inversion periodic structure at an intersection angle with respect to a predetermined polarization inversion region at a formation position of the optical waveguide core. For example, by selecting the formation position indicated by the line 124, periodic polarization inversion regions at the positions at which optical waveguide cores will be formed are all constituted by the polarization inversion structure A in which the polarization inversion period is L1. The optical waveguide core formed at the position indicated by the line 124 is formed such that an intersection angle with respect to the polarization inversion regions is a predetermined angle θ. The optical waveguide cores formed at the positions indicated by the lines 125 and 126 are similar except that polarization inversion periods of selected polarization inversion regions are L2 and L3. Therefore, as indicated by 124 to 126 in FIG. 12(b), polarization inversion periods of the optical waveguide cores 124 to 126 formed at the positions indicated by the lines 124 to 126 are polarization inversion periods L4, L5, and L6, which are constant and greater than the periods L1, L2, and L3 (L1<L2<L3).

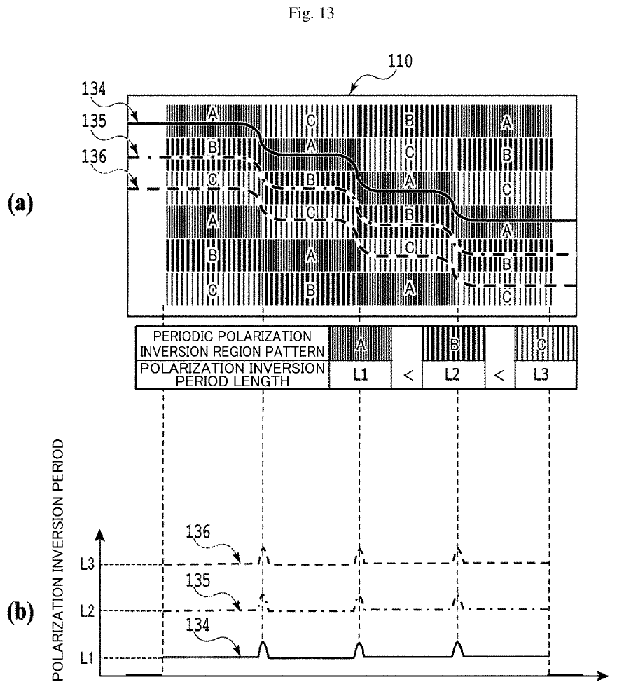

Further, for example, as indicated by lines 134 to 136 in FIG. 13(a), a position at which an optical waveguide core is formed may be selected such that the optical waveguide core passes over periodic polarization inversion regions such that the polarization inversion region intersection angle becomes 0 degree as much as possible. In this case, as shown in the figure, positions at which optical waveguide cores are formed are selected such that they are connected by an S-shaped curve between periodic polarization inversion regions.

FIG. 13(b) shows polarization inversion periods of the optical waveguide cores 134 to 136 formed at the positions indicated by the lines 134 to 136 in the process 34. As indicated by 134 to 136 in FIG. 13(b), the optical waveguide cores 134 to 136 formed at the positions indicated by the lines 134 to 136 in FIG. 13(a) have some pulse-like disturbance in polarization inversion periods because the intersection angle with respect to the polarization inversion regions is not 0 degrees at S-shaped curve positions, but the respective polarization inversion periods are approximately set to L1, L2, and L3. In this manner, in a case where the positions at which the optical waveguide cores are formed are connected by an S-shaped curve between the periodic polarization inversion regions, the intersection angle with respect to the polarization inversion regions can also be set to an arbitrary angle other than 0 degrees.

Although the periodic polarization inversion regions disposed in the bonded substrate 110 are arranged in a 6×4 two-dimensional array form in this embodiment, the number of periodic polarization inversion regions arranged in the bonded substrate may be other than that. The number of periodic polarization inversion regions arranged in the bonded substrate 110 may be appropriately selected in accordance with a film thickness distribution variation pattern assumed to be corrected. Further, although three kinds of polarization inversion structures having different polarization inversion period lengths are shown, four or more kinds of polarization inversion structures may be used. In this case, by preparing many kinds of polarization inversion structures having different polarization inversion period lengths, a local distribution of polarization inversion periods can be finely adjusted in response to a film thickness distribution pattern. Moreover, the intervals of the polarization inversion period lengths of the types of polarization inversion structures having different polarization inversion periods do not need to be equal.

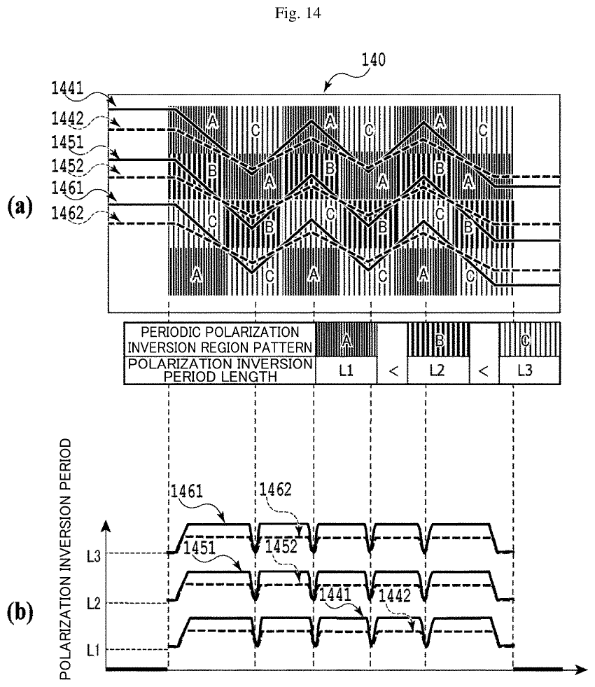

Next, another aspect of the manufacturing method of the fourth embodiment of the present disclosure will be described with reference to FIG. 14. As shown in FIG. 14(a), in this aspect, 24 polarization inversion regions constituted by any of polarization inversion structures A, B, and C with different polarization inversion periods having three kinds of period lengths L1, L2, and L3 are formed in a bonded substrate 140 in a 4×6 two-dimensional array form on an optical waveguide core substrate in the process 32 shown in FIG. 3.

Although the plurality of periodic polarization inversion regions shown in FIG. 14 are arranged such that adjacent periodic polarization inversion regions have different polarization inversion structures. Further, three kinds of polarization inversion regions constituted by the polarization inversion structures A, B and C in the vertical direction (direction parallel to polarization boundary lines) in the figure are repeated as A, B, and C, and set in a pattern in which three sets of two arrays, shifted vertically one by one, are repeated horizontally in the horizontal direction of the figure (direction perpendicular to the polarization boundary lines). When such an arrangement of the polarization inversion regions is used, by selecting an optical waveguide core formation position bent in zigzag as indicated by line 1441 in FIG. 14(a), an optical waveguide core can be formed using a path that passes through a polarization inversion region with the same periodic polarization inversion period (a polarization inversion region constituted by the polarization inversion structure A in the case of the line 1441) and has an intersection angle with respect to the polarization inversion region which is approximately a predetermined angle.

In the optical waveguide core formed at the position of such a path, as indicated by 1441 in FIG. 14(b), some pulse-like disturbance in polarization inversion periods occurs at the bent portion of the optical waveguide core, but the optical waveguide core approximately has a polarization inversion period length greater than L1 in accordance with the intersection angle with respect to the polarization inversion region. In the case where a waveguide core formation position indicated by line 1442 in FIG. 14(a) is selected, the intersection angle with respect to the polarization inversion region can be made less than in the case where the line 1441 is selected. As shown in FIG. 14(b), the polarization inversion period of the optical waveguide core formed at the position of this path has a period length less than 1441.1451, 1452, 1461, and 1462 are similar except that the size of the period length of the polarization inversion period changes with reference to L2 and L3.

As described above, this aspect not only utilizes the polarization inversion periods of the polarization inversion regions arranged in a two-dimensional array form, but also makes it possible to finely adjust the values of the polarization inversion periods between discrete periodic polarization inversion regions.

In this aspect, as in the example described with reference to FIG. 13, an optical waveguide core formation position may be selected such that an optical waveguide core passes over the periodic polarization inversion regions such that the periodic polarization inversion region intersection angle becomes 0 degree as much as possible by using a path in which positions at which the optical waveguide core is formed between periodic polarization inversion regions are connected by an S-shaped curve. Further, the concept of the number of periodic polarization inversion regions arranged in the bonded substrate and the number of kinds of periodic polarization inversion structures having different polarization inversion periods, and the materials of the optical waveguide core substrate and the substrate to be bonded are the same as those in the manufacturing method of the embodiment shown in FIG. 11, and therefore description thereof will be omitted.

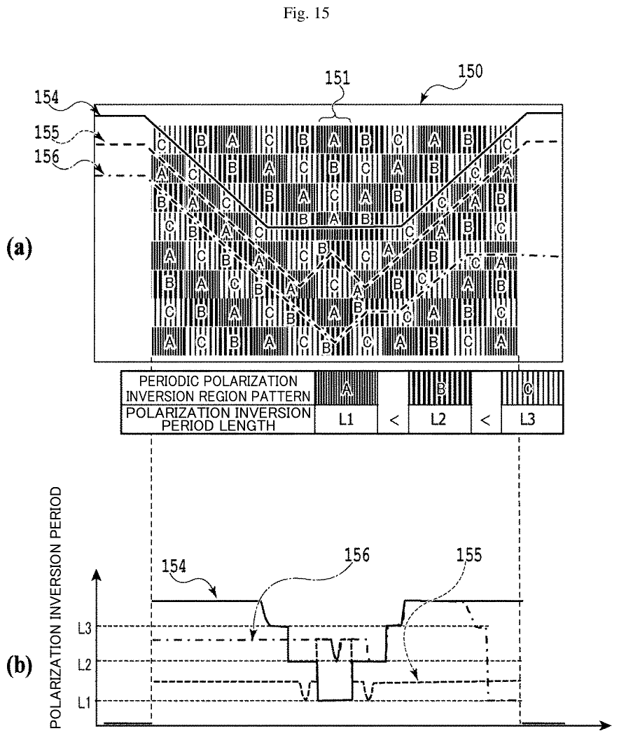

Further, another aspect of the manufacturing method of the fourth embodiment of the present disclosure will be described with reference to FIG. 15. As shown in FIG. 15(a), in this aspect, 88 polarization inversion regions constituted by any of polarization inversion structures A, B, and C with different polarization inversion periods having three kinds of period lengths L1, L2, and L3 (L1<L2<L3) are formed in a bonded substrate 150 in an 8×11 two-dimensional array form on an optical waveguide core substrate in the process 32 shown in FIG. 3.

The plurality of periodic polarization inversion regions shown in FIG. 15(a) are arranged such that three kinds of periodic polarization inversion regions are symmetrical about the sixth column 151 from the left. Further, in this aspect, adjacent periodic polarization inversion regions are arranged to have different polarization inversion periods, and arranged in the same repeating pattern in the horizontal direction (direction perpendicular to polarization boundary lines) of the figure starting from column 151 such that they are arranged in the same repeating pattern in the vertical direction (direction parallel to the polarization boundary lines) of the figure. For example, when the substrate material and the core material have different elastic modulus (Young's modulus) and thermal expansion coefficients, and a bonded substrate is fabricated through temperature change such as plasma or thermal bonding, warpage is likely to occur in the center symmetry of the substrate (wafer). Therefore, since a tendency of film thickness change in the center symmetry of the substrate (wafer) is likely to occur empirically after grinding and polishing the substrate, the array close to the center symmetry as shown in FIG. 15(a) is useful when a wavelength conversion element is fabricated using a bonded substrate.

Further, in FIG. 15(a), positions at which optical waveguide cores 154 to 156 will be formed in an optical waveguide core layer of the bonded substrate 150 in the process 34 shown in FIG. 3 are indicated by the lines 154 to 156. In the manufacturing method of this aspect, any of the optical waveguide cores 154 to 156 is formed through the process 34 which is a process after the processes 31 to 33, as in the manufacturing method of each embodiment described above.

By selecting the positions indicated by the lines 154 to 156 in FIG. 15(a) and forming the optical waveguide cores, the optical waveguide core formed by selecting the lines 154 has a local distribution of polarization inversion periods having a downward convex shape at the center as indicated by 154 in FIG. 15(b). Similarly, the optical waveguide core formed by selecting the line 155 has a local distribution of polarization inversion periods having an upward convex shape at the center, and the optical waveguide core formed by selecting the line 156 has a local distribution of polarization inversion periods having a convex shape upward only on the right side. In this example, the concept of the number of periodic polarization inversion regions arranged in the bonded substrate and the number of kinds of periodic polarization inversion structures having different polarization inversion periods, and the materials of the optical waveguide core substrate and the substrate to be bonded are the same as those in the manufacturing method of the embodiment shown in FIG. 11, and thus the description thereof will be omitted.

As described above, in the manufacturing method of the fourth embodiment of the present disclosure, it is possible to select, adjust, and control arbitrary change in polarization inversion periods in the step of the subsequent process for processing optical waveguide cores by arranging periodic polarization inversion regions to be formed in advance in the process of forming a bonded substrate and selecting an optical waveguide core formation position in the subsequent process of forming an optical waveguide. As a result, a wavelength conversion element including an optical waveguide core having a periodic polarization inversion structure with locally different polarization inversion periods can be fabricated using one substrate.

Therefore, for example, the wavelength conversion element in which the polarization inversion period of the polarization inversion region is locally adjusted in the step of the process 34 can be fabricated in response to a processing error generated in the processes 31 to 33 shown in FIG. 3.

### EXAMPLES

Hereinafter, the present disclosure will be described in more detail by examples, but the present disclosure is not limited to these examples.

### Example 1

As example 1, a light wavelength conversion element is fabricated through the manufacturing method of the first embodiment of the present disclosure.

In example 1, the polarization inversion region shown in FIG. 5(a) is formed in the optical waveguide core substrate through the processes 31 and 32 shown in FIG. 3. Specifically, the front and rear surfaces of a Z-axis cut LiNbO₃ substrate is immersed in a lithium chloride aqueous solution, a voltage of DC 1 kV or more is applied to align the polarization domain of LiNbO₃ on the entire surface of the substrate, a photoresist pattern of several m thickness of a periodic polarization inversion pattern of 30×30 mm square is formed on one surface, and an Au metal film is deposited on the entire surface of the surface on which the photoresist is formed. Thereafter, the front and rear surfaces are again immersed in a lithium chloride aqueous solution, and a voltage of DC 1 kV or more is applied to cause polarization inversion to fabricate a LiNbO₃ substrate (optical waveguide core substrate) having a periodic polarization inversion region of 30×30 mm square size.

Thereafter, a bonded substrate is fabricated in the process 33. Specifically, the LiNbO₃ substrate is bonded to a Z-axis cut LiTaO₃ substrate, and is thinned by grinding and polishing to fabricate a bonded substrate which is a substrate with an optical waveguide core layer having a periodic polarization inversion region of a partial 30×30 mm square.

Then, in the process 34, an optical waveguide core pattern having a predetermined intersection angle with respect to the periodic polarization inversion region illustrated in FIG. 5(a) is formed using a photoresist, and a ridge-shaped optical waveguide is fabricated through dry etching using Ar plasma. In example 1, for comparison, optical waveguide cores are fabricated at the positions indicated by the lines 52, 53 and 54 in FIG. 5(a).

The optical characteristics of the optical waveguide are evaluated by performing optical connection using a polarization holding fiber whose tip has been subjected to ball-tip processing, and the transmission loss spectrum near 1550 nm and the emission spectrum of second harmonic generation (SHG) light near 775 nm are evaluated using a wavelength variable light source, an SC light source, an optical spectrum analyzer or the like. As a result, even in the case of optical waveguides formed of the same periodic polarization inversion region, as a result of comparison of optical waveguides having different intersection angles with respect to the polarization inversion region, a result that the SHG light wavelength increases as the intersection angle increases is obtained. This result shows that wavelength-converted light can be controlled by selecting the intersection angle with respect to the polarization inversion region in the process 34 of forming an optical waveguide core. Therefore, it is ascertained that an error can be compensated by adjusting the polarization inversion period of the polarization inversion structure of the optical waveguide core.

### Example 2

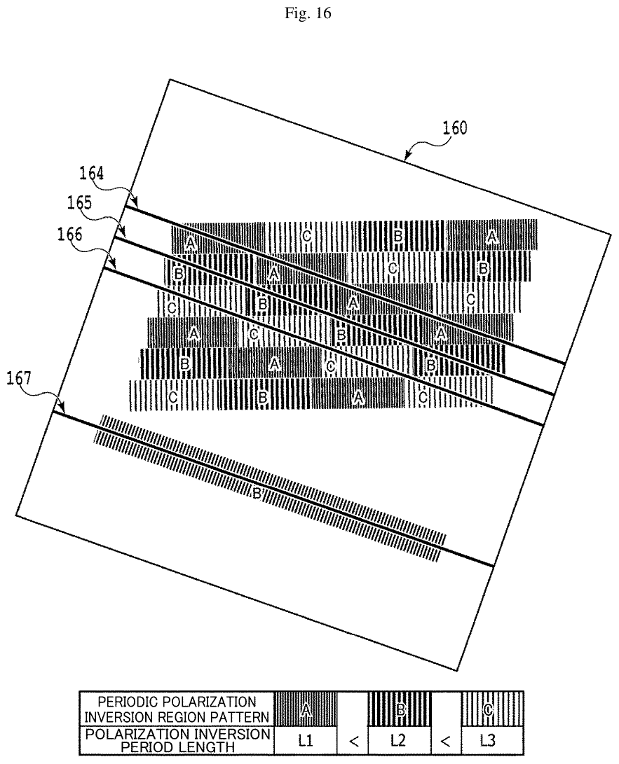

Next, example 2 will be described with reference to FIG. 16. As example 2, a wavelength conversion element is manufactured through the manufacturing method of the fourth embodiment. In the processes 31 and 32 shown in FIG. 3, 24 periodic polarization inversion regions are formed on an optical waveguide core substrate in a 6×4 two-dimensional array form shown in FIG. 16. Specifically, as in example 1 described above, the front and rear surfaces of a Z-axis cut LiNbO₃ substrate are immersed in a lithium chloride aqueous solution, and a voltage of DC 1 kV or more is applied to align the polarization domain of LiNbO₃ on the entire surface of the substrate.

Then, with the 24 periodic polarization inversion regions constituted by any of polarization inversion structures A, B, and C with different polarization inversion periods having three kinds of periodic lengths L1, L2, and L3 in a 6×4 two-dimensional array form, as shown in FIG. 16, a photoresist pattern having a thickness of several μm arranged in a pattern corresponding to one polarization inversion region having a period length L2 is formed as a comparison object at a position at which the waveguide core 167 of FIG. 16 on one surface with an in-plane size of 10 mm×5 mm, and an Au metal film is deposited on the entire surface of the surface on which the photoresist is formed.

Thereafter, the front and rear surfaces are again immersed in a lithium chloride aqueous solution, and a voltage of DC 1 kV or more is applied to cause polarization inversion to fabricate a LiNbO₃ substrate (optical waveguide core substrate) having a region of 40 mm×30 mm square including a plurality of periodic polarization inversion regions arranged as shown in FIG. 16. However, for comparison, a polarization inversion region of 40 mm×5 mm with an L2 polarization inversion period is also fabricated on a part of the substrate as shown in FIG. 16. In this example, the polarization inversion periods L1, L2, L3 are respectively set to 16.9 m, 17.0 m, 17.1 m.

Thereafter, the LiNbO₃ substrate is bonded to a Z-axis cut LiTaO₃ substrate through the process 33, and is thinned by grinding and polishing to fabricate a substrate (bonded substrate) with an optical waveguide core layer having a thickness of about 6 m. The arrangement of the 24 polarization inversion regions formed in the optical waveguide core layer of the bonded substrate of this example is the same as that shown in FIG. 11. FIG. 16 differs from the structure shown in FIG. 11 in that the direction of the polarization inversion boundary lines of the polarization inversion structure of the periodic polarization inversion region formed on the bonded substrate 160 are formed at an angle with respect to each side of the substrate. Due to this difference, even when the optical waveguide core is formed at a predetermined intersection angle with respect to the periodic polarization inversion region, the optical waveguide core can be formed in a linear optical waveguide core pattern.

Using the bonded substrate obtained as described above, in the process 34, a pattern of linear optical waveguide cores corresponding to the respective positions of the optical waveguide core formation positions 164, 165, and 166 shown in FIG. 16 is formed using a photoresist, and a ridge-shaped optical waveguide core is fabricated at the positions indicated by the lines 164, 165, and 166 shown in FIG. 15 through dry etching using Ar plasma. For comparison, a ridge-shaped optical waveguide core is fabricated at the position indicated by the line 167.

As in example 1 described above, the optical characteristics of the optical waveguide are evaluated by performing optical connection using a polarization holding fiber whose tip has been subjected to ball-tip processing, and the transmission loss spectrum near 1550 nm and the emission spectrum of second harmonic generation (SHG) light near 775 nm are evaluated using a wavelength variable light source, an SC light source, an optical spectrum analyzer or the like.

As a result, in example 2, a result that the SHG light wavelength of the optical waveguide formed at the position indicated by the line 165 in FIG. 16 is longer than the optical waveguide SHG light peak of the optical waveguide to be compared formed at the position indicated by the line 167 in FIG. 16 is obtained. This is because the polarization inversion period of an optical waveguide formed at an intersection angle with respect to the predetermined periodic polarization inversion region becomes longer.

Further, a result that the SHG light wavelengths of the optical waveguides formed at the respective positions indicated by the lines 164, 165, and 166 sequentially increase in the order of polarization inversion periods of 164<165<166 is obtained. This result shows that, in the process 34 of forming an optical waveguide core, wavelength-converted light can be controlled by selecting the position at which the optical waveguide core will be formed to select a periodic polarization wavelength region in which the optical waveguide core will be formed, and adjusting the intersection angle of the optical waveguide with respect to the periodic polarization inversion region. Therefore, it is ascertained that an error can be compensated by adjusting the polarization inversion period of the polarization inversion structure of the optical waveguide core.

As described above, according to the present disclosure, it is possible to compensate for variations in optical characteristics of wavelength-converted light caused by the film thickness distribution of an optical waveguide core layer, which occur in the process before the process of forming an optical waveguide core, in the step of the process of forming the optical waveguide core, and therefore, it is possible to realize a method of manufacturing a wavelength conversion device having excellent yield. Further, since a polarization inversion period of a polarization inversion structure of an optical waveguide core can be selected and adjusted at least locally in the step of the process of forming the optical waveguide core, for example, when an array-form wavelength conversion device in which a plurality of same wavelength conversion characteristics are arranged and required is fabricated, the manufacturing yield can be greatly improved. Further, by forming an optical waveguide having a plurality of polarization inversion period structures having different polarization inversion periods by using the manufacturing method of the present disclosure, a wavelength conversion device that can be used in a wider-band light wavelength band can be provided.

### INDUSTRIAL APPLICABILITY

The present invention can provide a manufacturing method for wavelength conversion elements capable of significantly improving a fabrication yield compared to conventional manufacturing methods.

1. A manufacturing method for a wavelength conversion element, the method comprising:
a first process of forming an optical waveguide core substrate having at least one or more periodic polarization inversion region with a second-order nonlinear effect;
a second process of bonding the optical waveguide core substrate to a substrate having a refractive index lower than a refractive index of the optical waveguide core substrate at least in a range of used light wavelengths to form a bonded substrate, and thinning the optical waveguide core substrate to form an optical waveguide core layer; and
a third process of processing the optical waveguide core layer of the bonded substrate to form an optical waveguide core,
wherein, in the third process, a polarization inversion period of a periodic polarization inversion structure of the formed optical waveguide core is adjusted at least locally by selecting a formation position of the optical waveguide core with respect to the at least one or more periodic polarization inversion region.

2. The manufacturing method for a wavelength conversion element according to claim 1, wherein, in the third process, the polarization inversion period of the periodic polarization inversion structure of the formed optical waveguide core is adjusted at least locally by selecting an intersection angle of the optical waveguide core with respect to the periodic polarization inversion region.

3. The manufacturing method for a wavelength conversion element according to claim 1, wherein the polarization inversion period of the periodic polarization inversion structure of the formed optical waveguide core is adjusted at least locally by forming at least two or more periodic polarization inversion regions having different polarization inversion periods in the optical waveguide core substrate such that the periodic polarization inversion regions are arranged in an array form in a direction of polarization boundary lines in the first process, and selecting a periodic polarization inversion region where the optical waveguide core is formed from the at least two or more periodic polarization inversion regions having different polarization inversion periods in the third process.

4. The manufacturing method for a wavelength conversion element according to claim 1, wherein the polarization inversion period of the periodic polarization inversion structure of the formed optical waveguide core is adjusted at least locally by forming at least four or more periodic polarization inversion regions having different polarization inversion periods such that the periodic polarization inversion regions are arranged in a two-dimensional array form in a direction perpendicular to polarization boundary lines and a direction parallel to the polarization boundary lines in the first process, and selecting a periodic polarization inversion region where the optical waveguide core is formed from the at least four or more periodic polarization inversion regions having different polarization inversion periods in the third process.

5. The manufacturing method for a wavelength conversion element according to claim 1, wherein the polarization inversion period of the periodic polarization inversion structure of the formed optical waveguide core is adjusted at least locally by forming at least four or more periodic polarization inversion regions having different polarization inversion periods such that the periodic polarization inversion regions are arranged in a two-dimensional array form in a direction perpendicular to polarization boundary lines and a direction parallel to the polarization boundary lines in the first process, and selecting at least one periodic polarization inversion region where the optical waveguide core is formed from the at least four or more periodic polarization inversion regions having different polarization inversion periods and further selecting an intersection angle of the optical waveguide core with respect to the selected periodic polarization inversion region in the third process.

6. The manufacturing method for a wavelength conversion element according to claim 1, wherein LiNbO₃ (lithium niobate), KNbO₃ (potassium niobate), LiTaO₃ (lithium tantalate), LiNb₍ₓ₎Ta₍₁₋ₓ₎O₃ (0≤x≤1) (lithium tantalate with indefinite composition), or KTiOPO₄ (potassium titanate phosphate), or a material containing at least one selected from Mg (magnesium), Zn (zinc), Sc (scandium), or In (indium) as an additive thereto is used for the optical waveguide core substrate and the substrate.
